(19) United States
(12) Patent Application Publication
(10) Pub. No.: US 2009/0049378 A1
(43) Pub. Date: Feb. 19, 2009

(54) METHOD AND COMPUTER PROGRAM FOR ASSOCIATING ELEMENT DIAGRAMS WITH APPLICATIONS

(75) Inventors: Asaf CARMEL, Tel Aviv (IL); Meni TITO, Giva'ataim (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP AG., Walldorf (DE)

(21) Appl. No.: 11/837,555

(22) Filed: Aug. 13, 2007

(51) Int. Cl. G06F 3/00

(52) U.S. Cl. 715/700

(57) ABSTRACT

A method and computer program for enabling a user of a computer application modeled with one or more element diagrams to view and relate to the element diagram and follow the flow of the process modeled through the computer diagrams. The method attaches to the computer program the element diagrams and components for viewing and relating to the element-diagram without introducing further code into the original computer application.

### TECHNICAL FIELD

The present invention relates to element modeled computer applications in general, and to a method and computer program for associating a modeling-element scheme with an application in run-time, in particular.

### BACKGROUND

Element-modeled computer applications refer to computer programs programmed through reference to modeling elements, such as real-world objects, data elements or others. For example, in a business programming environment, elements can represent customers, products, receipts, payments, and others, or collections of the above. A program may relate to placing an order, in which a customer orders a number of products, a receipt is generated and payment is transferred. In scientific or statistical applications, the elements can relate to products of an experiment, statistical data or the like, and an application may relate, for example, to a statistical analysis over experimental data derived from relevant elements.

In some environments, a user such as a programmer is offered a graphic user interface for constructing an element-based program or application. Through such user interface, the programmer may select elements, define activities to be performed over the elements, relations between elements, data transfer between elements, or the like. The programmer preferably designs an element diagram, for example by dragging or otherwise placing GUI objects representing elements, connecting them with links that may represent activities such as input/output, mathematical or other activities, and defining user-interface for the end-user, including for example data entry fields, output presentation or the like. During or after the model construction, code is generated, in an automatic or semi-automatic manner, and optionally compiled.

Such application is relatively easy to design to a person who is familiar with the real-world elements and the requirements of the underlying subject matter, since the programming is directly related to the elements. However, once the application is completed, users of the application who may include not only the end-users but also development personnel such as quality assurance teams, performance evaluators and others, lose connection to the elements upon which the application was constructed. The users see only the input and output as defined by the programmer, and not the elements, their interrelations, associated data, relations between the elements and the output, and others. Thus, such users can not directly locate design problems, such as reference to incorrect elements, errors in associating elements, and others. The users are further disabled from performing statistical analysis on the application, evaluating parts of the applications, such as the correctness or resource requirements of an activity, retrieving data from a data element, or the like.

There is thus a need for a method and computer program for enabling users of an element-designed application to view, relate or manipulate the elements upon which the application was constructed, their interrelationships and data. However, providing access to elements from an application should not introduce problems, slow down, increase resource requirements, or otherwise harm the execution of the application.

### SUMMARY

The subject matter discloses a method and apparatus for enabling a user of an application developed using one or more object diagrams, the option to vie and relate to the object diagram. Viewing the object diagram in run-time, enables a user to analyze the application, relate, find and locate problems, analyze performance and other activities. The element diagram or diagrams, and one or more components for showing them are attached to the application, thus providing these abilities.

One aspect of the disclosure relates to a computerized system executing an element-related computerized application describing one or more processes modeled by one or more element diagrams, a preferred embodiment of a method for enabling a user to relate to the processes associated with the element-related computerized application, the method comprising: associating the element diagrams created during design-stage or development stage, with the element-related application to obtain an extended application; associating a component for presenting the element diagrams from the extended application; and enabling the user to invoke the extended application. The method optionally comprises a step of displaying in ran-time the element diagrams to the user. The method can further comprise the step of developing a component selected from the group consisting of: an invocation handler; a checkpoint handler; a performance assessment handler; a statistical analysis handler; and an expression evaluation handler. Optionally, the method comprises a step of stopping execution of the extended application in one or more checkpoints, or a step of displaying one or more values associated with one or more elements to the user, or a step of parsing or evaluating one or more expressions. The process is optionally selected from the group consisting of: a business process; a statistical process; and a scientific process.

Another aspect of the disclosure relates to an extended element-related computer program, for enabling a user of an element-related computerized application describing one or more processes modeled by one or more element diagrams, to relate to the processes associated with the element-related application, the extended computer program comprising: an application providing significantly the same functionality provided by the element-related computerized application; the element diagrams; an element diagram user interface component for displaying the element diagrams; and an invocation handler for invoking the extended element-related computer program. The computer program can further comprise one or more components from the group consisting of: a checkpoint handler; a performance assessment handler; a statistical analysis handler; and an expression evaluation handler. The computer program optionally comprises an extended user interface component for displaying user interface items additional element diagrams.

Yet another aspect of the disclosure relates to a computer readable storage medium containing a set of instructions for a general purpose computer, the set of instructions comprising: associating one or more element diagrams with an element-related application to obtain an extended application; associating one or more components for presenting the element diagrams; and enabling a user to invoke the extended application.

### BRIEF DESCRIPTION OF THE DRAWINGS

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

FIG. 1 shows a prior art schematic illustration of the development and usage process of an element-based application;

FIG. 2 is a user interface of a program utilizing preferred embodiments of the disclosed subject matter;

FIG. 3 is a flow chart of the main steps in a method for providing to a user of an application constructed upon elements, access to the elements, in accordance with the disclosure; and

FIG. 4 is a block diagram of the main components in a preferred embodiment of the computer program, in accordance with the disclosure.

### DETAILED DESCRIPTION

In exemplary embodiments of the disclosed subject matter, one or more element diagrams created by a developer of an element-based computerized application during design-time or design-stage or development-time or development stage of an application, are attached to the applications and are available to a user of the applications in run-time. One or more user interface components enable a user to view in runtime one or more element diagrams created in design-time and embedded into the application, and thus relate to elements and to the flow of the application rather than just view the application's input and output. The user can stop execution of the application in desired stages during the execution path of the program, view and manipulate data related to one or more elements, execute specific activities, monitor the execution, perform statistical analysis, and otherwise follow the execution of the program. The application is an element-related application, i.e. the application describes the flow of a process by modeling in design-time or in development time one or more element diagrams, the element participating in the element-diagram representing real-world elements or objects, data elements or objects or others. However, the elements and the flow are generally not available to a user of the application, rather the user interface as defined by the developer is presented to the user. The disclosed subject matter enables the attachment of the element diagrams used in modeling the processes associated with the application, to the application itself, thus enabling a user of the application to relate to the element diagrams and their flow in run-time.

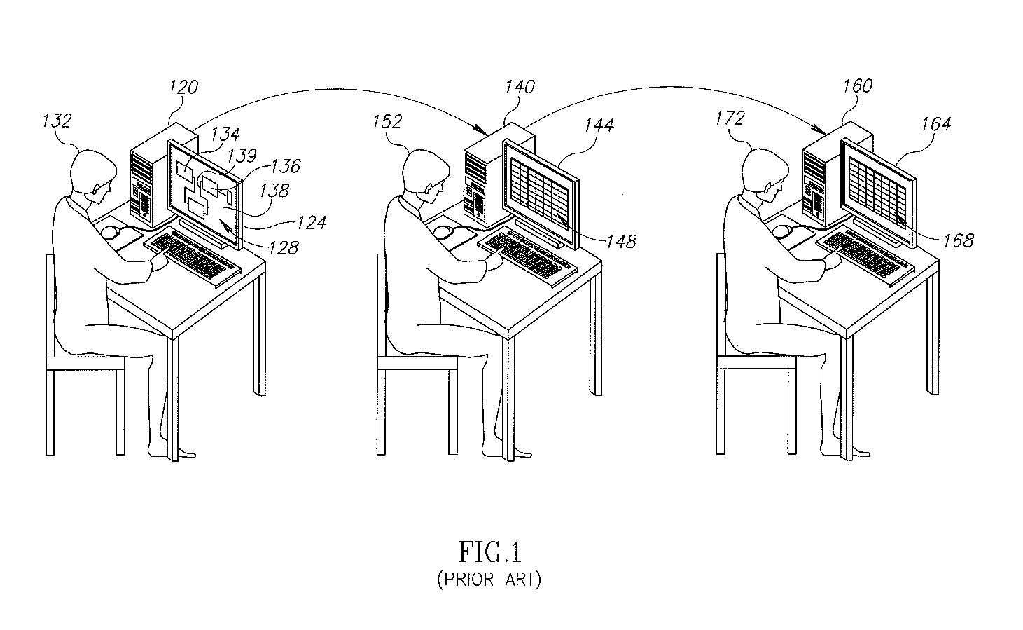

Referring now to FIG. 1, showing a prior art schematic illustration of the development and usage process of an element-based application. An application developer 132, who is preferably familiar with the subject matter of the application, is using during design time or development time of the application a computing platform 120 associated with a display device 124. Computing platform 120 executes a development program or application which enables developer 132 to develop element-related applications. The development program preferably provides developer 132 with user interface for modeling the element-related application by constructing one or more element diagrams such as element diagram 128. Element diagram 128 preferably comprises a graphic representation of one or more elements such as elements 134, 136, and connections between elements such as link 138, 139 which represent connections between elements, operations on data retrieved from elements such as database tables, or the like. Element diagram 128 can be generated by dragging, copying or otherwise placing Graphic User Interface (GUI) elements representing data elements, real-world elements, or others and defining one or more processes associated with the applications in terms of the elements and their interrelationships. During or after the element-based model is constructed, computer code is generated and an executable, library or any other unit of the application comprising computer instructions is available. The element-related application is made available to computing platform 140 by remote access, downloading, sending, transferring over digital storage media or the like. A user, preferably a quality assurance person, a performance evaluator or another user other than an end-user is using the application executed by computing platform 140 in run-time, and relates to its input and output via devices such as display 144. Display 144 displays output 148 as defined and programmed by develop 132, rather than element diagram 128 upon which the application was generated. Thus, user 152 can not relate to the elements upon which the application was developed, can not evaluate data related to a specific element, and is generally limited to he options enabled by programmer 132 or to usage of program debugging tools, which also do not relate to the elements. The underlying elements are referred to and manipulated within the application instructions, but are hidden from the user since the graphic representation is unavailable.

Once user 152 furnished testing, evaluating or otherwise working with the application, it is optionally returned to developer 132 for corrections or enhancements, and the process repeats, until the application is satisfactory. Then the application is transferred to end-user 172, executing the application on computing platform 160 and viewing its output 168 on display 164. Similarly to user 152, also end-user 172 can only view the output of the application, and can not relate to the elements upon which the application was developed or evaluate data related to a specific elements, and is also generally limited to he options enabled by programmer 132 or to usage of program debugging tools, which also do not relate to the elements.

The application is transferred to computing platform 160 via remote access, downloading, sending, transferring over digital storage media or the like. Each of computing platforms 120, 140, 160 is optionally a computerized system such as a mainframe computer, a desktop computer, a network computer, a laptop computer, a handheld device such as a Personal Digital Computer, or any other type of computing platform provisioned with a memory device, a CPU or microprocessor device, and several I/O ports. Each of computing platforms 120, 140, 160 also comprises or has access to a storage device for storing relevant applications or data. Each of displays 124, 144 or 164 is any type of display, such as an LCD, CRT or others. In other alternatives, an of displays 124, 144 or 164 may be replaced with other output devices, including audio, visual, audiovisual or the like devices through which the user can relate to the output.

The disclosed method and computer program enable users such as user 152 and user 172 to view the element-diagram and relate to the elements and their relationships in ran-time, as designed by developer 132 in design-time or development-time. The software data and operations associated with the elements are used within the application, but the element diagrams are not available, thus disabling a user from relating to the elements and to the flow of the application. Embedding the diagrams within the application, and maintaining the links between the elements and their visual representations provides users with the abilities to relate to the elements and the flow.

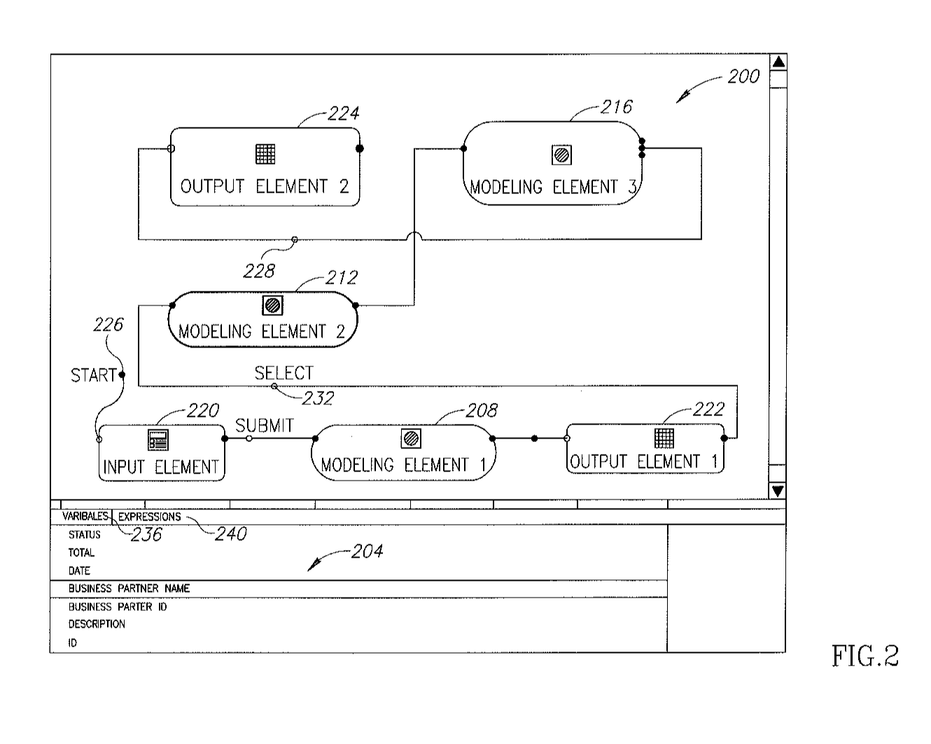

Referring now to FIG. 2, showing a preferred embodiment of the user interface provided to a user of an element-modeled application generated in accordance with preferred embodiments of the disclosed subject matter. The user viewing the user interface of FIG. 2 is a user other than a developer of the application, such as user 152 or user 172 of FIG. 1. The user interface can be shown to a user of the application on another window than the window of the application itself, on part of the window of the application, on the same window with different opacity levels, on alternating windows, or the like. The user interface is optionally shown to a user of the application as a default, is invoked when the user presses a predetermined key or otherwise indicates. Yet another alternative is that the diagram is shown on specific points during the execution as indicated by the developer, or the like. The user interface preferably comprises an element diagram pane 200 and a data pane 204. Element diagram pane 200 shows to the user in run-time one or more of the one or more element diagrams created by the application developer during design-time or development time. If the application comprises multiple element diagrams, optionally two or more diagrams are shown on different tabs. Alternatively, a list of all diagrams is shown, optionally with thumbnail pictures, and the user selects which diagram should be presented in full detail. Multiple diagrams can also be shown if an application comprising nested diagrams is executed, wherein executing commands within a more internal level opens and activates an additional tab showing the internal level. When exiting the internal level, the new tab may disappear and control may be returned to the diagram showing the upper level. In yet another alternative, only the diagram active on a particular time is presented, and prior to activation of the application, the diagram comprising the starting point is presented. Element diagram pane 200 presents the elements as designed by the application developer, including for example round-cornered modeling element 1 (208), modeling element 2 (212) and modeling element 3 (216) which relate to elements from the domain of the application, and input output elements which are related to the user interface of the application, such as straight-cornered input element 1 (220), output element 1 (222) and output element 2 (224). The user can set checkpoints on specific points during the execution, preferably before or after an element is invoked, such as point 232 or point 228. When the execution of the application reaches any of the checkpoints, execution halts and the user can view information and perform actions. Halting the execution at checkpoints is enabled through linkage between the element diagrams and the application itself, which contains references to the real-world objects or data objects associated with the modeling elements.

Information pane 204 can show the values of variables associated with one or more of the elements shown in element diagram pane 200. In a preferred embodiment, clicking or otherwise pointing at an element in element diagram pane 200 show its variables on information pane 204. Clicking or pointing on another element, will show the variables relevant to the other element. Preferably, variables are shown if tab 236 is selected within pane 204. In another preferred embodiment, if expressions tab 240 is selected, the user can type, drag or otherwise indicate expressions to be evaluated, the expressions optionally relating to constants, variables of one or more elements whether the elements are shown in the diagram or not, a combination thereof, or the like.

When in a specific checkpoint, the user can advance to the next link, advance to the next checkpoint, evaluate performance of one or more actions, or the like.

In yet another preferred embodiment, complex checkpoints can be defined. For example, checkpoints can be associated in an “OR” relationship, i.e. execution halts when either of the checkpoints is reached; “AND” relationship in non-related activities, such as activities performed in parallel, meaning that execution halts when the two checkpoints are reached; or other combinations, conditioned checkpoints, counted checkpoints, i.e. stop only in the n-th time execution reaches this checkpoint, or the like.

It will be appreciated by a person skilled in the art that the user interface shown and detailed in association with FIG. 2 is exemplary only and should not be construed as an obligatory presentation. Thus, more, less, or different views of the underlying element-model designed and shown to a user, and more, less, or different options enabled to a user, are considered to be a part of the disclosed subject matter.

Referring now to FIG. 37 showing a block diagram of the main components in an application constructed in accordance with the disclosed subject matter. The application is referred to as extended element application, to differentiate from an application constructed using an element model but not enabling a user to relate to the elements in runtime, as in the prior art. The extended element application comprises a varying part 304 related to the specific application, varying part 304 comprising the original element-related application 306, or another application or part thereof providing significantly the same functionality as the original application. No code or computer instructions relevant to showing or manipulating the element diagrams are inserted into the original application. Varying part 304 further comprises element diagrams 307 as designed by application developer 132 of FIG. 1 and used for modeling the processes of the original application. Thus, element diagrams 307 are embedded within, or attached to the application and the combined information can be reviewed. Extended element application 300 farther comprises a user interface component 308 for presenting the user interface associated with the elements and element diagrams to the user, A sub component of user interface component 308 is element diagram user interface component 312, which is significantly the same as the user interface component used for example by developer 132 of FIG. 1 for developing the element-related application. User interface component 308 further comprises extended user interface component 316, for displaying the additional parts of the user interface, such as information pane 204 of FIG. 1, displaying checkpoints, or the like. Application 300 further comprises components for enabling a user to perform actions and manipulations using the extended application, including but not limited to: invocation handler 320, checkpoints handler 324, performance assessment handler 328, statistical analysis handler 330, and expression evaluation handler 332. Each of invocation handler 320, checkpoint handler 324, performance assessment handler 328, statistical analysis handler 330, and expression evaluation handler 332 preferably communicate with varying components 304, which comprise the information related to the execution of the application on one hand, and with user interface components 308, for enabling a user to perform the relevant actions and for associating the graphic representation of the elements with the elements in application 306 on the other hand.

Invocation handler 320 is useful in invoking the extended applications, for example as a default when the application of varying parts 304 is invoked, when the user indicates that he or she wish to invoke the extended application, or in any other situation. Checkpoint handler 324 is responsible for manipulating checkpoints, halting execution at checkpoints, or the like, resolving “And”, “OR”, or other relations between checkpoints as discussed in association with FIG. 2 above, and the like. Performance assessment handler 328 enables a user to evaluate the performance or resource consumption of any action or object, by determining the increase in resource consumption between a checkpoint before and after the relevant activity. Statistical analysis handler 330 enables a user to retrieve statistical information related to the element scheme or to one or more elements within the scheme, such as amount of data retrieved form an element, average and distribution of retrieval time, number of accesses, or the like. Thus, statistical analysis handler 330 optionally provides information about usage patterns within the element diagram, and can provide information about bottlenecks or weak areas of the application or one or more elements or element diagrams thereof.

Expression evaluation handler 332 optionally lets a user view the values of variables existing within the code, and further optionally interprets additional expressions and operators entered by the user, evaluates them and presents the resulting values. The expressions to be parsed or evaluated by expression evaluation handler 332 can be phrased using the same syntax as offered to the application developer, or any other syntax, including more, less or different operators. In a preferred embodiment, user interface component 308, invocation handler 320, checkpoint handler 324, performance assessment handler 328, statistical analysis handler 330, and expression evaluation handler 332 are components that do not change between various developed applications, and are linked with varying part 304 when the application is deployed or is otherwise made ready for execution. Thus, user interface component 308, invocation handler 320, checkpoint handler 324, performance assessment handler 328, statistical analysis handler 330, and expression evaluation handler 332 are non-intrusive, and do not change the size, speed, resource requirements or other characteristics of the original application, as often happens, for example, in debugable versions of applications.

It will be appreciated by a person skilled in the art that the disclosed structure is exemplary only, and that different divisions into components can be designed without deviating form the spirit of the disclosed subject matter. In particular, invocation handler 320, checkpoint handler 324, performance assessment handler 328, and expression evaluation handler 332 can be designed so that parts thereof are comprised within user interface component 308.

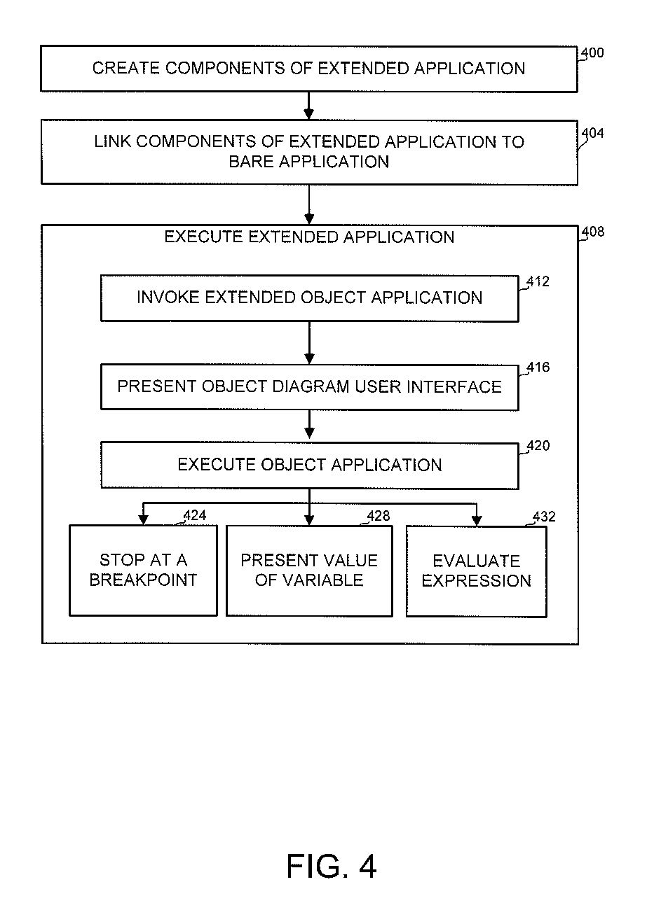

Referring now to FIG. 4, showing a flowchart of the main steps in a method for creating and using an element-related application in accordance with the disclosed subject matter.

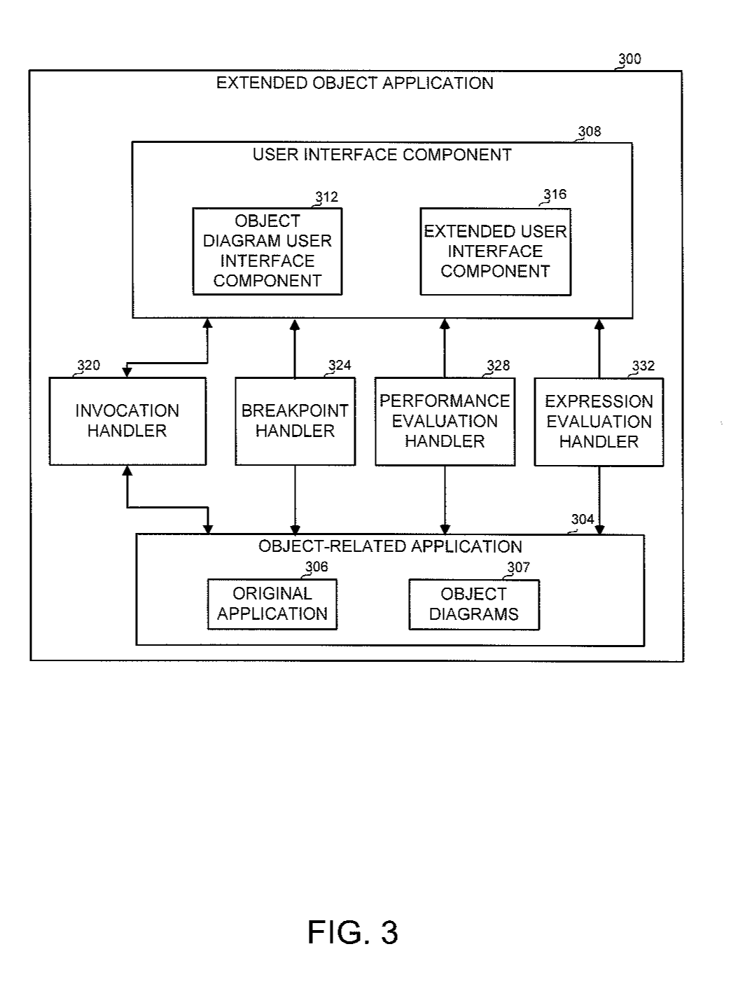

On step 400, specific components related to using the application are developed, including invocation handler 320, checkpoint handler 324, performance assessment handler 328, statistical analysis handler 330, and expression evaluation handler 332 and extended user interface component 316, all of FIG. 3 above. On step 404, the abovementioned components, together with element diagram user interface component 312 which may be identical or similar to the user interface which enables an application developer to develop an element-related application, are linked, or otherwise associated with an element-related application, to create an extended application. On step 406, one or more element diagrams upon which the application was developed, are linked or otherwise associated with the application, preferably with the executable unit of the application. The application, including one or more element diagrams and component for viewing and relating thereto is referred to as “extended application”.

On step 408, the extended application is executed. Execution starts with the extended application being invoked on step 412. The application can be invoked using a predetermined key sequence, voice activated commands or the like. On step 416, one or more element diagrams as created by the application developer is displayed to a user of the extended application, such as user 152 or user 172 of FIG. 1. On step 420 the element-based application, as developed by the application developer is executed. During execution, the user can perform one or more of the operations enabled by the extended application, which relate to the element diagram, including stopping at a checkpoint on step 424, displaying a value associated with an element on step 428, or parsing or evaluating an expression on step 432.

The disclosed method and computer program integrate or embed element schemes created during the design time or development time of an application within the application, to create an extended application. Constructing the element diagrams are constructed as part of the modeling of the application and describe the process behind the application rather than the user-interface of the application. The extended application displays in rum-time the element schemes or diagrams although not part of the user interface, and enables the user to follow the process modeled by the element diagrams by viewing and manipulating the element diagrams. Thus, the extended application enables further developers or end users executing the application to view the element diagrams, follow their flow, stop when one or more conditions occur, relate to the elements and the flow, view and manipulate data associated with elements, find problems in the design of the application, measure quality parameters such as performance, check the compatibility of the application to the requirements, and others. Enabling access to the diagrams from the extended application is done by embedding, integrating or otherwise adding the diagrams to the executable or another unit representing the application, and adding specific components for viewing and manipulating the element diagrams and elements thereof. Thus, providing access to the code is non-intrusive, so the code is unchanged and its performance does not degrade. The method and components can be activated with any modeling language or environment, and does not require specific settings or features.

Structure and acts described herein are replaceable by equivalents, which perform the same function, even if the structure or acts are different, as known in the art. Therefore, only the elements and limitations as used in the claims limit the scope of the invention. When used in the following claims, the terms “comprise”, “include”, “have” and their conjugates mean “including but not limited to”.

1. In a computerized system executing an element-related computerized application describing an at least one process modeled by an at least one element diagram, a method for enabling a user to relate to the at least one process associated with the element-related computerized applications the method comprising:
associating the at least one element diagram created during design-stage or development stage, with the element-related application to obtain an extended application;
associating an at least one component for presenting the at least one element diagram from the extended application; and
enabling the user to invoke the extended application.

2. The method of claim 1 further comprising the step of displaying in run-time the at least one element diagram to the user.

3. The method of claim 1 further comprising the step of developing an at least one component selected from the group consisting of: an invocation handler; a checkpoint handler; a performance assessment handler; a statistical analysis handler; and an expression evaluation handler

4. The method of claim 1 further comprising the step of stopping execution of the extended application in an at least one checkpoint.

5. The method of claim 1 further comprising the step of displaying an at least one value associated with an at least one element to the user.

6. The method of claim 1 further comprising the step of parsing or evaluating an at least one expression.

7. The method of claim 1 wherein the process is selected from the group consisting of: a business process; a statistical process; and a scientific process.

8. An extended element-related computer program, for enabling a user of an element-related computerized application describing an at least one process modeled by an at least one element diagram, to relate to the at least one process associated with the at least one element-related application, the extended computer program comprising:
an application providing significantly the same functionality provided by the element-related computerized application;
the at least one element diagram;
an element diagram user interface component for displaying the at least one element diagram; and
an invocation handler for invoking the extended element-related computer program.

9. The computer program of claim 8 further comprising an at least one component from the group consisting of: a checkpoint handler; a performance assessment handler; a statistical analysis handler; and an expression evaluation handler.

10. The computer program of claim 8 further comprising an extended user interface component for displaying user interface items additional to the least one element diagram.

11. A computer readable storage medium containing a set of instructions for a general purpose computer, the set of instructions comprising:
associating an at least one element diagram with an element-related application to obtain an extended application;
associating an at least one component for presenting the at least one element diagram;
enabling a user to invoke the extended application.
